(19) United States
(12) Patent Application Publication
(10) Pub. No.: US 2001/0014248 A1
(43) Pub. Date: Aug. 16, 2001

(54) Mechanical pencil

(76) Inventor: Takahiko Suzuki, Kawagoe-shi (JP)

Correspondence Address: McGinn & Gibb, PLLC, Suite 200, 8321 Old Courthouse Road, Vienna, VA, 22182-3817, US

(21) Appl. No.: 09/776,880

(22) Filed: Feb. 6, 2001

(30) Foreign Application Priority Data
Feb. 16, 2000 (JP) 2000-038806

(51) Int. Cl. A45D 40/20; B43K 21/22

(52) U.S. Cl. 401/92; 401/88

(57) ABSTRACT

A mechanical pencil for using a lead effectively includes a tip pipe for protecting a lead. The tip pipe is mounted to a front end portion of the mechanical pencil so as to be able to axially project from or retract into a tip opening of the front end portion of the mechanical pencil. The tip pipe is preferably made of metal and, at least one slit (and preferably two slits) axially extending from the tip, preferably is formed on the tip pipe so as to be mutually approximately in parallel. In the case of two slits, the two slits are arranged circumferentially at less than substantially 180E intervals and approximately in parallel with an axial direction and a portion between these two slits forms an elastic piece. Because the elastic piece of the tip pipe tends to move inwardly so as to make a surface contact against the lead, the force holding the lead is increased.

### BACKGROUND OF THE INVENTION

1. Field of the Invention

The present invention relates to a mechanical pencil and, more particularly to a mechanical pencil capable of effectively using a lead and shortening a length of a remnant lead to be discarded.

2. Description of the Related Art

A conventional mechanical pencil, as disclosed in Japanese Utility Model Registration No. 2544453, includes a coil-like spring inside a tip pipe. The coil-like spring is formed at an inside thereof with an internal diameter portion that has a diameter slightly smaller than that of a lead so as to contact the lead. Alternatively, a linear spring which has a bending portion bending toward a center of an internal diameter of the tip pipe is arranged inside the tip pipe of the mechanical pencil. The linear spring is formed at the bending portion with an internal diameter portion that has an internal diameter slightly smaller than that of the lead so as to contact the lead. Fine particles are stuck on the surface of the linear spring. Hence, when the lead operatively contacts the coil-like spring or the linear spring by a knocking action, the spring is deformed, thereby holding the lead by an appropriate force.

However, in such mechanical pencils, it is difficult to make a very small size coil-spring or linear spring capable of being housed inside the tip pipe having a thin diameter, and to fix it inside the tip pipe. Thus, such a structure has not been put into practical use.

### SUMMARY OF THE INVENTION

In view of the foregoing and other problems, disadvantages, and drawbacks of the conventional methods and structures, an object of the present invention is to provide a mechanical pencil which can use the lead effectively and can be put simply into practical use.

To attain the above and other objects, the mechanical pencil according to the present invention includes a tip pipe fixedly or axially movably arranged on a front end portion thereof for surrounding a lead. At least one slit is provided on the tip pipe so as to increase a holding force of the tip pipe. Because the slit is arranged just on the tip pipe, such a mechanical pencil can be simply made and put into practical use. By arranging the slit on the tip pipe, the tip pipe can elastically contact the lead by utilizing the slit, thereby increasing the holding force of the lead.

At least two slits can be provided on the tip pipe and the slits may be set approximately in parallel with each other. Moreover, these two slits can be arranged circumferentially at less than substantially 180E intervals and approximately in parallel with an axial direction, and a portion of the tip pipe between the two slits forms an elastic piece.

Alternatively, these two slits can be also arranged circumferentially at about 180E intervals and approximately in parallel with an axial direction, and a portion of the tip pipe between the two slits forms an elastic piece. A surface of the elastic piece contacts the lead with an effectively increased holding force of the tip pipe.

Also, an outer (e.g., external) pipe can be coaxially arranged outside the tip pipe. Moreover, a tip of the tip pipe is preferably projected further than a tip of the outer pipe. By arranging the outer pipe, even when a strong writing pressure is applied to the tip pipe, the tip pipe having the slit(s) is prevented from largely expanding toward an outside diameter direction. Additionally, it is hard for the slits to be seen from the outside, thereby improving an outward appearance of the mechanical pencil. By allowing the tip of the tip pipe to project further than the tip of the outer pipe, a dead angle can be prevented from being formed by the outer pipe at the tip of the lead when a user uses the mechanical pencil.

When the tip pipe is made of metal, it can be formed with a thin-wall. Also, its shape can be maintained and it has a high bending strength.

Moreover, a thread or a longitudinal rib can be formed on an inner peripheral surface of the tip pipe. The contact of a top surface of the thread of the tip pipe or a top surface of the longitudinal rib of the tip pipe against the lead can further enhance the holding force of the tip pipe to the lead, as compared with a uniform contact of the tip pipe against the lead.

Optionally, an inner (e.g., internal) pipe can also be arranged coaxially inside the tip pipe. Preferably, a tip of the tip pipe is projected further than a tip of the inner pipe, and an inside diameter of a portion of the tip pipe projected from the inner pipe is set to be smaller than an inside diameter of a portion of the tip pipe not projected. By arranging the inner pipe, a flexural rigidity can be enhanced. The tip pipe can be made of resin, and the inner pipe can be made of metal. Also, by threading or by forming a longitudinal rib on the inner peripheral surface of the inner pipe, the holding force of the tip pipe to the lead can be further enhanced.

The present disclosure relates to subject matter contained in Japanese Patent Application No. 2000-038806, filed Feb. 16, 2000, which is expressly incorporated herein by reference in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is a longitudinal half sectional view showing a first embodiment of a mechanical pencil according to the present invention;

FIG. 2 is an enlarged sectional view of a tip portion of the first embodiment;

FIG. 3 is a sectional view taken along a line 3-3 in FIG. 2;

FIG. 4 is a view taken along an arrow 4 in FIG. 3;

FIG. 5 is an enlarged sectional view of a tip portion of a second embodiment of the present invention;

FIG. 6 is a view taken along an arrow 6 in FIG. 5;

FIG. 7 is an equivalent view to FIG. 6 of a third embodiment of the present invention;

FIG. 8 is an enlarged sectional view of a tip portion of a fourth embodiment of the present invention;

FIG. 9 is an enlarged sectional view of a tip portion of a fifth embodiment of the present invention;

FIG. 10 is an enlarged sectional view of a tip portion of a sixth embodiment of the present invention;

FIG. 11 is a view taken along an arrow 11 in FIG. 10;

FIG. 12 is an enlarged sectional view of a tip portion of a seventh embodiment of the present invention;

FIG. 13 is an enlarged sectional view of a tip portion to show a modified example of the seventh embodiment; and

FIG. 14 is an enlarged sectional view of a tip portion to show another modified example of the seventh embodiment.

### DETAILED DESCRIPTION OF THE PREFERRED EMBODIMENTS

Referring now to the drawings, embodiments of the present invention will be described below.

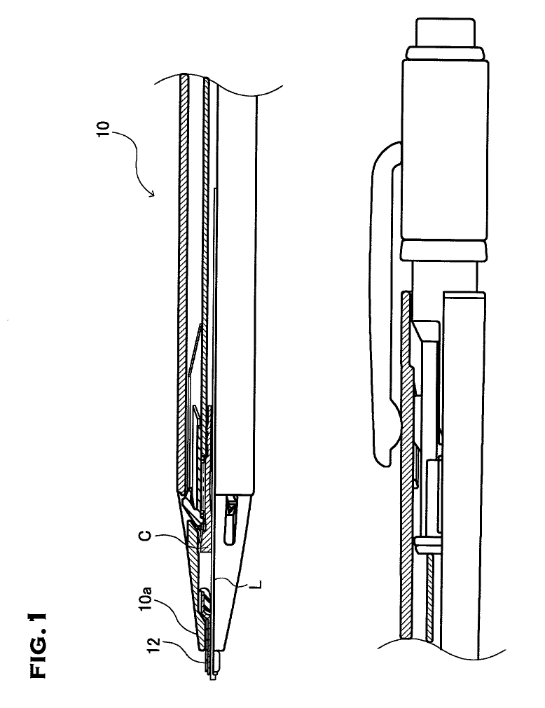

FIGS. 1-4 illustrate a first embodiment of the present invention in which reference numeral 10 denotes a mechanical pencil and reference numeral 10a denotes a front end portion of the mechanical pencil.

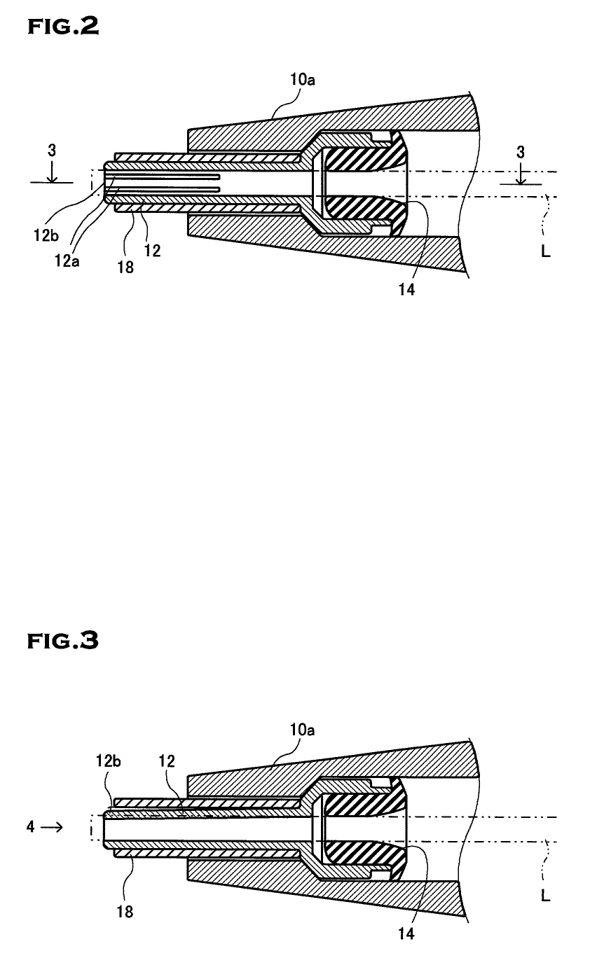

As shown enlargedly in FIG. 2, the front end portion 10a is provided with a tip pipe 12 for protecting a lead. The tip pipe 12 can project from or retract into a tip opening of the front end portion 10a in an axial direction of the mechanical pencil. A packing rubber 14 is inserted in a rear portion of the tip pipe 12. The packing rubber 14 holds the lead by giving a frictional resistance to the lead, and holds the tip pipe 12 by receiving a frictional resistance from an inner peripheral surface of the front end portion 10a.

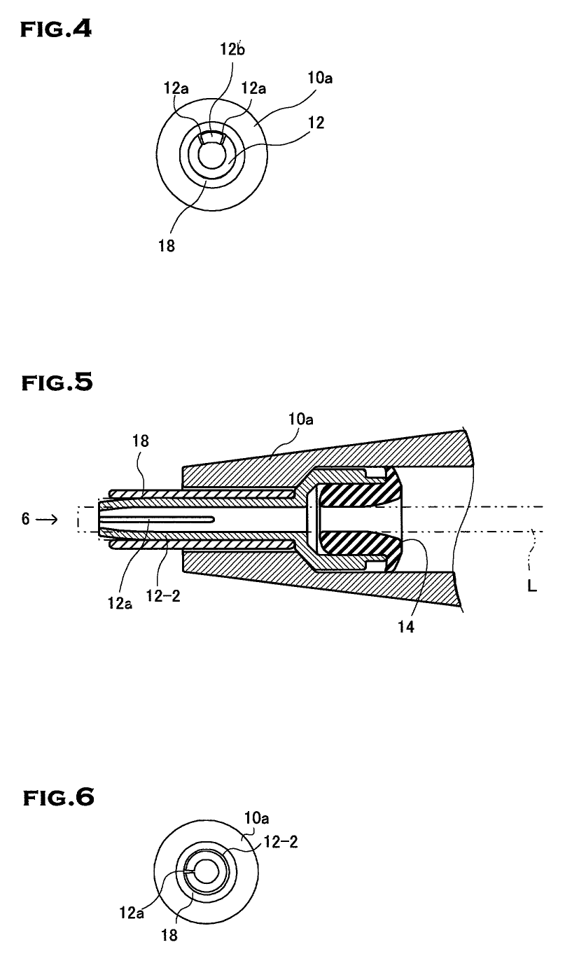

The tip pipe 12 is preferably made of metal and, in the tip pipe 12, two slits 12a, 12a, axially extending from a tip of the tip pipe 12, are formed approximately in parallel with each other. The two slits 12a, 12a are, as shown in FIG. 4, arranged circumferentially at less than substantially 180E intervals and approximately in parallel with an axial direction. A portion between these two slits 12a, 12a is an elastic piece 12b. The slits 12a, 12a can be formed with a cutter by cutting from the tip of the tip pipe 12. After cutting from the tip by the cutter, if some burrs remain inside or outside the tip pipe 12, then a proper treatment may be made by a reamer, a chemical polishing or the like.

A stem portion of the tip pipe 12 is pressingly inserted into an outside (e.g., outer or external) pipe 18 preferably made of metal, and both the tip pipe 12 and the outside pipe 18 form a coaxially double pipe structure. The outside pipe 18 prevents the elastic piece 12b of the tip pipe 12 from expanding outwardly in a radial direction.

A position of the tip of the tip pipe 12 and a position of the tip of the outside pipe 18 may be flush with each other. However, as in the present embodiment, preferably the tip of the tip pipe 12 is projected a little more than the tip of the outside pipe 18 because a dead angle is hard to form on the tip of the lead while a user uses the mechanical pencil.

In the mechanical pencil 10 described above, the elastic piece 12b of the tip pipe 12 tends to move inwardly so that the lead L is pressed by the surface of the elastic piece 12b, as shown by virtual lines in FIG. 3, thereby enhancing a force holding the lead L. Hence, even when the length of the lead L becomes shorter than the length between the tip of the tip pipe 12 and a tip of a chuck C (e.g., see FIG. 1) by consuming the lead, and the lead L is free from a tightening force from the chuck C, since the force holding the lead by the tip pipe 12 is enhanced, the lead still can be used and the lead also can be prevented from rotating. Hence, the lead L can be used effectively and a length of the remnant lead to be discarded can be made shorter. Moreover, even if the elastic piece 12b tends to be deformed outwardly in a radial direction when a strong writing pressure is applied to the tip pipe 12, the outside pipe 18 restrains such deformation of the elastic piece 12b so that the force holding the lead is not reduced.

If both the tip pipe 12 and the outside pipe 18 are made of metal, then a wall thickness of each of them can be made thin, thereby providing a user with a sense of writing stability and physical comfort during writing. Because the slits 12a, 12a can be simply formed, the mechanical pencil described above can be made practicable simply and easily.

### Second Embodiment

FIGS. 5 and 6 show a second embodiment of the present invention. In the drawings, the same members as those of the first embodiment are assigned the same reference numerals, and, for brevity, detailed descriptions thereof will be omitted.

In this embodiment, one slit 12a axially extending from a tip of a tip pipe 12-2 is formed on one place of the tip pipe 12, and an inside diameter of the tip pipe 12-2 is decreased (e.g., tapered) toward the tip at a front end portion of the tip pipe 12-2.

In the mechanical pencil according to this embodiment, since the inside diameter of the tip pipe 12-2 is decreased toward the tip, a lead L is pressed by the inner peripheral surface of the tip of the tip pipe 12-2, thereby increasing the force holding the lead L. Because the slit 12a exists there, even if the inside diameter of the tip of the tip pipe 12-2 is equal to or less than the outside diameter of the lead L, the lead L still can pass through the tip pipe 12-2 while receiving an appropriate elastic holding force from the tip of the tip pipe 12-2 without being damaged. Hence, the same operation efficiency as that of the first embodiment can be obtained.

### Third Embodiment

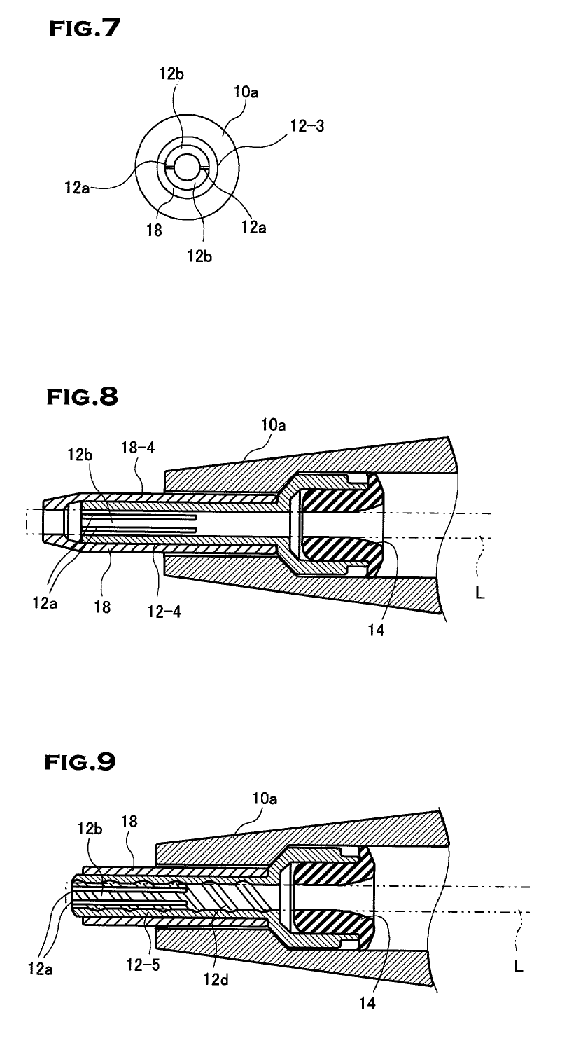

FIG. 7 shows a third embodiment of the present invention. In FIG. 7, the same members as those of the preceding embodiments are assigned the same reference numerals, and for brevity, the detailed description thereof will be omitted.

In a tip pipe 12-3 of this embodiment, two slits 12a, 12a are formed circumferentially at substantially 180E intervals and mutually approximately in parallel, and portions between these two slits 12a, 12a are elastic pieces 12b, 12b.

Additionally, in this embodiment, because the surfaces of the elastic pieces 12b, 12b elastically contact a lead L so as to enhance the force holding the lead, the same operation efficiency as that of the first embodiment can be obtained.

### Fourth Embodiment

FIG. 8 shows a fourth embodiment of the present invention. In FIG. 8, the same members as those of the preceding embodiments are assigned the same reference numerals, and, for brevity, the detailed description thereof will be omitted.

This embodiment is different from the first embodiment in that a tip of an outside pipe 18-4 is projected more than a tip of a tip pipe 12-4 and a front portion of the outside pipe 18-4 is formed in a dip such that a diameter thereof decreases inwardly.

Further, in this embodiment, with the elastic piece 12b of the tip pipe 12-4, the same operation efficiency as those of the preceding embodiments can be obtained. Because the front end portion of the outside pipe 18-4 is formed to have a smaller diameter, a dead angle is hard to form at a tip of a lead during writing.

### Fifth Embodiment

FIG. 9 shows a fifth embodiment of the present invention. In the drawing, the same members as those of the preceding embodiments are assigned the same reference numerals, and, for brevity, the description thereof will be omitted.

This embodiment is different from the first embodiment in that a thread 12d is formed on an inner surface of a tip pipe 12-5.

By forming the thread 12d in such a manner, the inner surface of the tip pipe 12-5 does not uniformly contact the lead, but instead dispersed portions of the top of a ridge of the thread contact the lead and a frictional resistance given to the lead L by the dispersed portions becomes large. Thus, the force holding the lead is increased, and the lead is more securely prevented from rotating.

### Sixth Embodiment

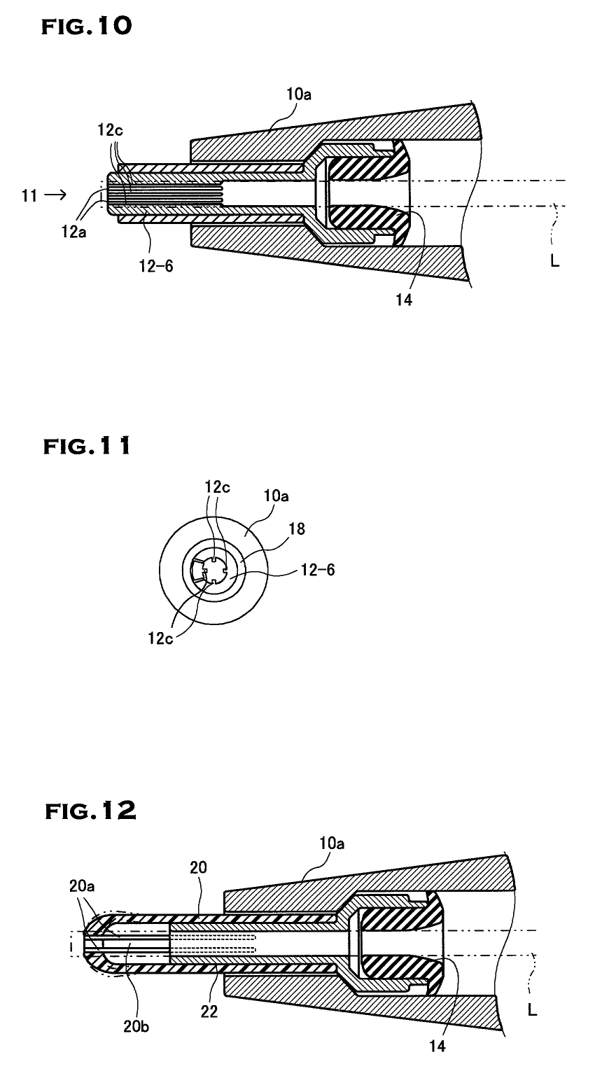

FIGS. 10 and 11 show a sixth embodiment of the present invention. In the drawings, the same members as those of the preceding embodiments are assigned the same reference numerals, and, for brevity, the description thereof will be omitted.

This embodiment is different from the first embodiment in that a plurality of longitudinal ribs 12c are formed on an inner surface of a tip pipe 12-6.

By forming the longitudinal ribs 12c in this manner, the inner surface of the tip pipe 12-6 does not uniformly contact the lead. Instead, dispersed portions of a top of the longitudinal ribs 12c contact the lead and a frictional resistance given to the lead L by the dispersed portions becomes large. Thus, the force holding the lead is increased, and the lead is more securely prevented from rotating.

### Seventh Embodiment

FIG. 12 shows a seventh embodiment of the present invention. In the drawing, the same members as those of the preceding embodiment are assigned the same reference numerals, and, for brevity, the description thereof will be omitted.

In this embodiment, a tip pipe 20 is preferably made of resin and, in this tip pipe 20, two slits 20a, 20a axially extending from a tip of the tip pipe 20 are formed mutually approximately in parallel. The two slits 20a, 20a are arranged circumferentially at less than substantially 180E intervals and approximately in parallel with the axial direction, and a portion between these two slits 20a, 20a forms an elastic piece 20b. Inside the tip pipe 20, an inside (e.g., inner or internal) pipe 22 preferably made of metal is further arranged, and a rear end of the inside pipe 22 extends rearwardly from the tip opening of a tip portion 10a, in which a packing rubber 14 is inserted. The tip pipe 20 has a front end portion further projected than the inside pipe 22 and the front end portion has a reduced (e.g., tapered) diameter in the direction of the tip.

The tip pipe 20 is fixed to the outer peripheral surface of the inside pipe 22 at its stem portion.

In the mechanical pencil described above, when a lead is used for writing, a portion of the lead is protected by the inside pipe 22 and its deflection or the like is prevented. Moreover, a vicinity of the tip of the lead receives an appropriate elastic holding force from the front end portion of the tip pipe 20.

When an inside diameter of the front end portion of the tip pipe 20 is set so as to become smaller in a natural state than an outside diameter of the lead, the elastic piece 20b holds the lead, with the elastic piece 20b itself being deformed toward the outside diameter so that the force holding of the tip pipe 20 is increased. Hence, the same operation efficiency as that of the first embodiment can be obtained.

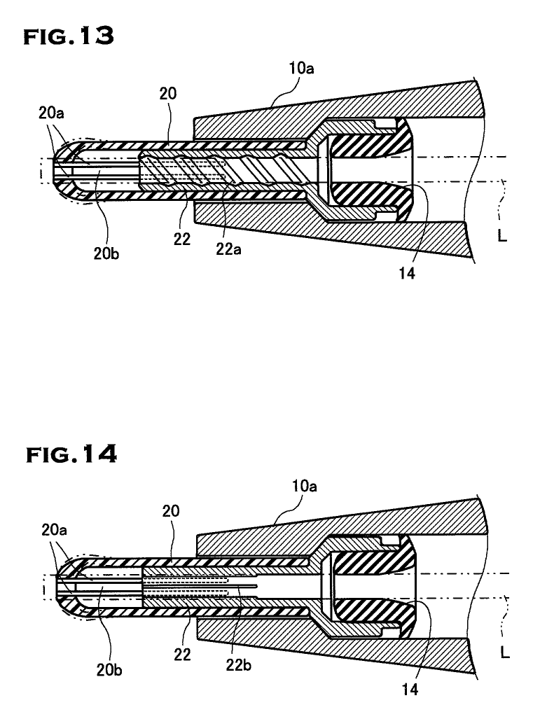

It is noted that, as a modified example of this embodiment, a thread 22a may be formed (e.g., see FIG. 13), or a longitudinal rib 22b may be formed (e.g., see FIG. 14) on the inner peripheral surface of the inside pipe 22, so that the force holding the lead can be further increased similarly to the fifth embodiment or the sixth embodiment.

In the embodiments described above, an exemplary tip pipe for projecting from and retracting into the front end portion 10a of the mechanical pencil, in concert with movement of the lead L, has been described. However, it will be clear that the present invention is not limited thereto and can be applied to a fixed type of tip pipe which is fixed and not movable to the front end portion 10a.

As described above, according to the present invention, by a simple configuration, the force holding the lead by the tip pipe can be increased and, even when the lead becomes shorter and the lead is released from the tightening power of the chuck, writing can be continuous and the rotation of the lead also can be restrained. Hence, the lead can be used effectively and a length of a remnant lead to be discarded can be made shorter.

While the invention has been described in terms of several preferred embodiments, those skilled in the art will recognize that the invention can be practiced with modification within the spirit and scope of the appended claims.

Having thus described my invention, what I claim as new and desire to secure by Letters Patent is as follows:

1. A mechanical pencil, comprising:
a tip pipe for surrounding a lead, said tip pipe being fixedly or axially movably disposed at a front end portion thereof,
wherein at least one slit is provided on said tip pipe so as to increase a force holding the lead by said tip pipe.

2. The mechanical pencil according to claim 1, wherein at least two slits are provided on said tip pipe, said slits being formed approximately parallel with each other.

3. The mechanical pencil according to claim 2, wherein said at least two slits are arranged circumferentially at less than substantially 180E intervals and approximately in parallel with an axial direction, and
wherein a portion of the tip pipe between the two slits forms an elastic piece.

4. The mechanical pencil according to claim 2, wherein said at least two slits are arranged circumferentially at about substantially 180E intervals and approximately in parallel with an axial direction, and
wherein portions of the tip pipe between the two slits form elastic pieces.

5. The mechanical pencil according to claim 1, further comprising an outer pipe coaxially arranged outside of said tip pipe.

6. The mechanical pencil according to claim 5, wherein a tip of said tip pipe is projected further than a tip of said outer pipe.

7. The mechanical pencil according to claim 1, wherein said tip pipe comprises metal.

8. The mechanical pencil according to claim 1, wherein a thread is formed on an inner peripheral surface of said tip pipe.

9. The mechanical pencil according to claim 1, wherein a longitudinal rib is formed on an inner peripheral surface of said tip pipe.

10. The mechanical pencil according to claim 1, further comprising an inner pipe is coaxially arranged inside of said tip pipe.

11. The mechanical pencil according to claim 10, wherein a tip of said tip pipe is projected further than a tip of said inner pipe and an inside diameter of a portion of the tip pipe projected from said inner pipe is set so as to be smaller than an inside diameter of a portion of the tip pipe not projected from said inner pipe.

12. The mechanical pencil according to claim 10, wherein said tip pipe comprises resin and said inner pipe comprises metal.

13. The mechanical pencil according to claim 10, wherein a thread is formed on the inner peripheral surface of said inner pipe.

14. The mechanical pencil according to claim 10, wherein a longitudinal rib is formed on an inner peripheral surface of said inner pipe.

15. A mechanical writing instrument, comprising:
a tip pipe for surrounding a writing medium, said tip pipe being fixedly or axially movably disposed at a front end portion thereof,
wherein at least one slit is provided on said tip pipe so as to increase a force holding the writing medium by said tip pipe.

16. The mechanical writing instrument according to claim 15, wherein at least two slits are provided on said tip pipe, said slits being formed approximately in parallel with each other.

17. The mechanical writing instrument according to claim 16, wherein said at least two slits are arranged circumferentially at less than substantially 180E intervals and approximately in parallel with an axial direction, and
wherein a portion of the tip pipe between the two slits forms an elastic piece.

18. The mechanical writing instrument according to claim 16, wherein said at least two slits are arranged circumferentially at about substantially 180E intervals and approximately in parallel with an axial direction, and
wherein portions of the tip pipe between the two slits form elastic pieces.

19. The mechanical writing instrument according to claim 15, further comprising an outer pipe coaxially arranged outside of said tip pipe.

20. The mechanical writing instrument according to claim 19, wherein the tip of said tip pipe is projected further than a tip of said outer pipe.
